(19) United States
(12) Patent Application Publication
(10) Pub. No.: US 2021/0365557 A1
(43) Pub. Date: Nov. 25, 2021

(54) POLICY BASED ACCESS CONTROL OF SUBSYSTEM ASSETS VIA EXTERNAL DEBUG INTERFACE

(71) Applicant: QUALCOMM Incorporated, San Diego, CA (US)

(72) Inventors: Jaydeep CHOKSHI, San Diego, CA (US); Miguel BALLESTEROS, Solana Beach, CA (US); Mahadevamurty NEMANI, San Diego, CA (US); Samar ASBE, San Diego, CA (US); Girish BHAT, San Diego, CA (US); Alan YOUNG, Carlsbad, CA (US); Victor WONG, San Diego, CA (US); Steven HALTER, San Diego, CA (US)

(21) Appl. No.: 16/880,819

(22) Filed: May 21, 2020

(51) Int. Cl. G06F 21/57; G06F 21/44; G06F 11/36; G06F 13/42

(52) U.S. Cl. CPC G06F 21/57; G06F 21/44; G06F 11/3664; G06F 2221/2141; G06F 2213/0038; G06F 2221/2103; G06F 13/42

(57) ABSTRACT

A method for external access control to protect system-on-chip (SoC) subsystems and stored subsystem assets is described. The method includes sensing, during a cold boot of an SoC hardware system, a debug fuse vector for access to SoC subsystems of an SoC owner and/or third-party subsystems of an SoC hardware architecture. The method also includes disabling access to each SoC subsystem with a blown fuse in the debug fuse vector. The method further includes re-enabling, by a secure root of trust, access to an SoC subsystem and/or a third-party subsystem for an external debugger when authentication of one or more debug certificates of a third-party owner of the external debugger is successful.

### BACKGROUND

### Field

The present disclosure generally relates to computer security. More specifically, aspects of the present disclosure relate to a method and apparatus for policy based access control of subsystem assets via an external debug interface.

### Background

Over the last decade, malicious software has become a pervasive problem for computer users. In particular, one type of malware may exhibit behaviors such as infecting, encrypting, deleting, and/or stealing files (hereinafter generally referred to as “file altering malware”). File altering malware targets computer systems for: (i) restricting access to portions of a computer system and demanding payment for the removal of the restriction, or (ii) infecting computer systems with information theft routines, which may seek to steal information such as (1) login credentials to applications, (2) system information, (3) file transport protocol (FTP) credentials, or the like. Infecting malware may target a computer architecture, such as a high-level operating system (HLOS) of the computer architecture of a system-on-chip.

System-on-chip (SoC) design is becoming more complex due to support for enhanced user features. An on-chip security infrastructure provides a method for controlling access to these SoC subsystems and assets. While there is adequate access control in place for on-chip clients, external access control to these SoC subsystems and assets from third-party original equipment manufacturers (OEMs) or end users, especially from an external debug standpoint, is desired.

### SUMMARY

A method for external access control to protect system-on-chip (SoC) subsystems and stored subsystem assets is described. The method includes sensing, during a cold boot of an SoC hardware system, a debug fuse vector for access to SoC subsystems of an SoC owner and/or third-party subsystems of an SoC hardware architecture. The method also includes disabling access to each SoC subsystem with a blown fuse in the debug fuse vector. The method further includes re-enabling, by a secure root of trust, access to an SoC subsystem and/or a third-party subsystem for an external debugger when authentication of one or more debug certificates of a third-party owner of the external debugger is successful.

A non-transitory computer-readable medium having program code recorded thereon for external access control to protect system-on-chip (SoC) subsystems and stored subsystem assets is described. The program code is executed by a processor. The non-transitory computer-readable medium includes program code to sense, during a cold boot of an SoC hardware system, a debug fuse vector for access to SoC subsystems of an SoC owner and/or third-party subsystems of an SoC hardware architecture. The non-transitory computer-readable medium also includes program code to disable access to each SoC subsystem with a blown fuse in the debug fuse vector. The non-transitory computer-readable medium further includes program code to re-enable, by a secure root of trust, access to an SoC subsystem and/or a third-party subsystem for an external debugger when authentication of one or more debug certificates of a third-party owner of the external debugger is successful.

A system for external access control to protect system-on-chip (SoC) subsystems and stored subsystem assets is described. The system includes a debug fuse vector to define access to SoC subsystems of an SoC owner and/or third-party subsystems of an SoC hardware architecture. The system also includes an access protection unit configured to prevent access to each SoC subsystem with a blown fuse in the debug fuse vector. The system further includes a secure root of trust configured to re-enable, by, access to an SoC subsystem and/or a third-party subsystem for an external debugger when authentication of one or more debug certificates of a third-party owner of the external debugger is successful.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily used as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIG. 1 illustrates an example implementation of a system-on-chip (SoC), including an external debug interface access control for SoC hardware subsystem assets, in accordance with certain aspects of the present disclosure.

FIG. 2 is a block diagram of the system-on-chip (SoC) of FIG. 1, illustrating the external debug interface access control for SoC hardware subsystem assets, in accordance with aspects of the present disclosure.

FIG. 3 is a block diagram of a configuration of external debug interface access control for system-on-chip (SoC) hardware architecture subsystem assets, in accordance with aspects of the present disclosure.

FIG. 4 is a block diagram of a configuration of a system-on-chip (SoC) hardware architecture to implement subsystem asset external access control, in accordance with aspects of the present disclosure.

FIG. 5 is a flow diagram illustrating a method for external access control to protect system-on-chip (SoC) subsystems and stored subsystem assets, according to aspects of the present disclosure.

FIG. 6 is a block diagram showing a wireless communications system in which a configuration of the disclosure may be advantageously employed.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. It will be apparent to those skilled in the art, however, that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality, in addition to or other than the various aspects of the disclosure set forth. It should be understood that any aspect of the disclosure disclosed may be embodied by one or more elements of a claim.

As described, the use of the term “and/or” is intended to represent an “inclusive OR,” and the use of the term “or” is intended to represent an “exclusive OR.” The word “exemplary” is used to mean “serving as an example, instance, or illustration.” Any aspect described as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure, rather than limiting the scope of the disclosure being defined by the appended claims and equivalents thereof.

System-on-chip (SoC) design is becoming more complex due to support for enhanced user features. Some examples of enhanced user features include an always on camera (AOC) for faster phone unlock as well as a payment authentication system using facial or finger print validation. Other enhanced user features include voice based input requests to perform tasks, as well as data transfers using a 5G channel interface. There are various SoC subsystems of an overall SoC hardware architecture designed to implement these enhanced user features. In operation, the various SoC subsystems generate and/or store various assets across the SoC hardware to provide the enhanced user features. The storage location used by the SoC subsystems to store these assets include control/status registers (CSRs), double data rate (DDR) memory, cryptographic storage, or other like privileged storage areas.

An on-chip security infrastructure provides a method for controlling access to the assets of the SoC subsystems when stored within the SoC subsystems. For example, access control is performed using an advanced reduced instruction set computing (RISC) architecture machine (ARM) based memory management unit (MMU), or a system MMU (SMMU) from a master side of the SoC hardware architecture. Conversely, an access protection unit (xPU) may provide access control from a slave side of the SoC hardware architecture. While there is an adequate access control in place for on-chip clients, external access control to these SoC subsystems and assets from third-party OEMs or end users is desired. For example, restricted external access control to a 5G algorithm processing subsystem, as well as a power management subsystem is desired. In particular, third-party OEM access to these SoC subsystems as well as certain assets may be strictly prohibited.

Aspects of the present disclosure are directed to solving these noted access control problems. One existing approach addresses the problem by restricting external access (e.g., debug access) to the SoC subsystems and assets at design time by blowing access control fuses at the factory before delivering a part including an SoC hardware architecture to third-party OEMs. Unfortunately, this solution has several drawbacks. First, the static decision is made early in the design stage; however, a dynamic decision, which is adjustable based on business needs or justification that may arrive or change in the future is preferable. In addition, the static decision to block access is limited to protecting assets that are within the SoC subsystem. Unfortunately, access to assets stored elsewhere in the SoC hardware architecture (e.g., CSRs, DDR, etc.) may be accessible. Aspects of the present disclosure address these limitations.

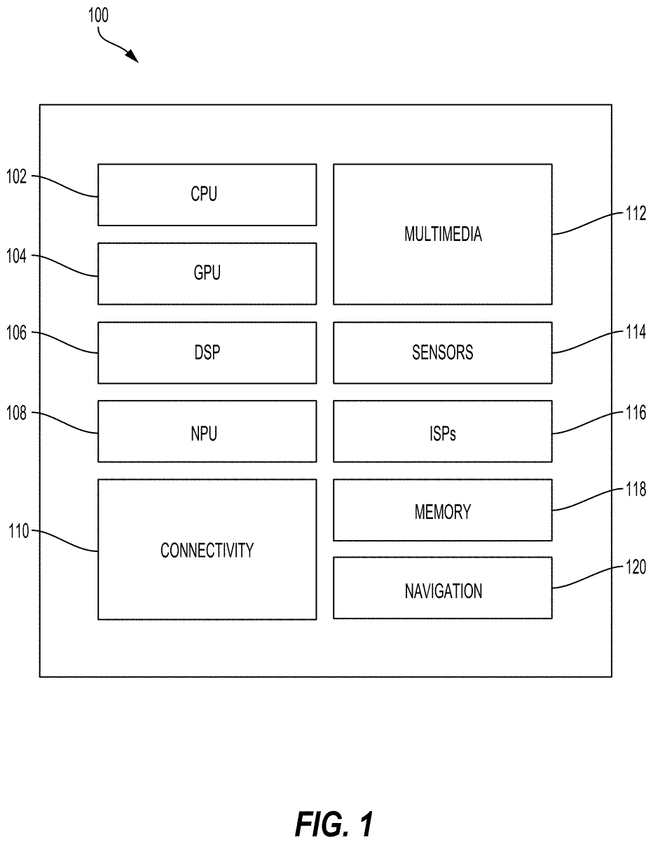

FIG. 1 illustrates an example implementation of a host system-on-chip (SoC) 100, which includes an external debug interface access control, configured to prevent unauthorized access to a system-on-chip (SoC) subsystem and protected assets, in accordance with aspects of the present disclosure. The host SoC 100 includes processing blocks tailored to specific functions, such as a connectivity block 110. The connectivity block 110 may include fifth generation (5G) connectivity, fourth generation long term evolution (4G LTE) connectivity, Wi-Fi connectivity, USB connectivity, Bluetooth® connectivity, Secure Digital (SD) connectivity, and the like.

In this configuration, the host SoC 100 includes various processing units that support multi-threaded operation. For the configuration shown in FIG. 1, the host SoC 100 includes a multi-core central processing unit (CPU) 102, a graphics processor unit (GPU) 104, a digital signal processor (DSP) 106, and a neural processor unit (NPU) 108. The host SoC 100 may also include a sensor processor 114, image signal processors (ISPs) 116, a navigation module 120, which may include a global positioning system, and a memory 118. The multi-core CPU 102, the GPU 104, the DSP 106, the NPU 108, and the multi-media engine 112 support various functions such as video, audio, graphics, gaming, artificial networks, and the like. Each processor core of the multi-core CPU 102 may be a reduced instruction set computing (RISC) machine, an advanced RISC machine (ARM), a microprocessor, or some other type of processor. The NPU 108 may be based on an ARM instruction set.

In an aspect of the present disclosure, the instructions loaded into the multi-core CPU 102 may include program code to sense, during a cold boot of an SoC hardware system, a debug fuse vector for access to SoC subsystems of an SoC owner and/or third-party subsystems of an SoC hardware architecture. The instructions loaded into the multi-core CPU 102 may also include program code to disable access to each SoC subsystem with a blown fuse in the debug fuse vector. In addition, the instructions loaded into the multi-core CPU 102 may include program code to re-enable, by a secure root of trust, access to an SoC subsystem and/or a third-party subsystem for an external debugger when authentication of one or more debug certificates of a third-party owner of the external debugger is successful.

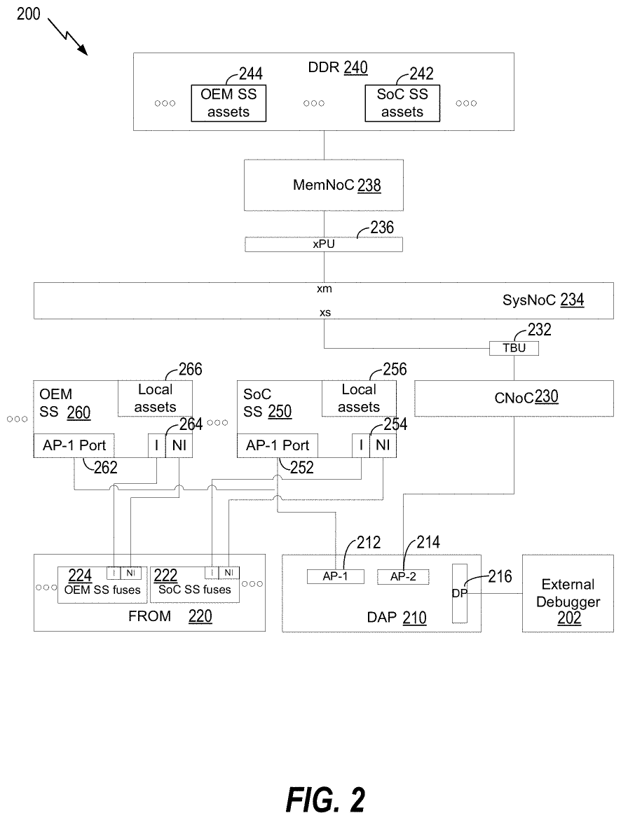

FIG. 2 is a block diagram of the host system-on-chip (SoC) 100 of FIG. 1, illustrating the external debug interface access control for system-on-chip (SoC) hardware architecture subsystem assets, in accordance with aspects of the present disclosure. In one configuration, an SoC hardware architecture 200 includes a fuse read only memory (FROM) 220, having a set of fuses for each subsystem (SS) of the SoC hardware architecture 200. As described, theses subsystems are referred to as “SoC subsystems” or “SoC SS” and other subsystems, such as third-party subsystems, referred to as original equipment manufacturer (OEM) subsystems, “OEM subsystems,” or “OEM SS.”

An on-chip security infrastructure provides a method for controlling access to assets (e.g., local assets 256 and 266) of the SoC subsystem 250 and the OEM subsystem 260. Restricted access by an external debugger 202 (e.g., a third-party OEM) to a subset of the SoC subsystem 250 and the OEM subsystem 260 is defined at design time. For example, the restricted access is defined by blowing fuses (e.g., 222 and 224) of the FROM 220 at the factory before delivering a part including the SoC hardware architecture 200 to a third-party OEM. In this configuration, the on-chip security infrastructure programs control signals 254 (e.g., invasive (I) and non-invasive (NI) access) of the SoC subsystem 250 and control signals 264 (e.g., I/NI access) of the OEM subsystem 260.

The external debugger 202 accesses the local assets 266 of the OEM subsystem 260 through a data port (DP) 216 of a debug access port 210. The data port 216 of the debug access port 210 provides a port of the external debugger 202 to connect for on-chip access to the SoC hardware architecture 200. The debug access port 210 also includes a first access port 212 (AP-1) and a second access port (AP-2) 214. The first access port 212 enables access to internal subsystem assets, such as the local assets 266 of the OEM subsystem 260. In addition, the second access port 214 enables access to subsystem assets on the SoC hardware architecture 200. That is, the debug access port 210 provides an interface for exposing on-chip assets to the external debugger 202.

In one configuration, the external debugger 202 accesses the local assets 266 through a port 262 (AP-1 port) of the OEM subsystem 260 using the data port 216 and the first access port 212 of the debug access port 210. In this example, access to the local assets 266 of the OEM subsystem 260 is enabled for the external debugger 202 through the control signals 264 (e.g., I/NI access), because the OEM SS fuses 224 of the FROM 220 are not blown. The external debugger 202, however, is prohibited from accessing the local assets 256 through an access port 252 (e.g., AP-1 port) of the SoC subsystem 250 by the control signals 254. In this configuration, access by the external debugger 202 is prohibited because the SoC SS fuses 222 of the FROM 220 were blown at the factory. Unfortunately, this solution has several drawbacks.

In particular, the static decision to blow fuses is made early in the design stage. By contrast, a dynamic decision that is adjustable based on business needs or a justification that may arrive or change in the future might be preferable. Furthermore, the static decision to block access is limited to protecting internal subsystem assets of the SoC subsystem 250 and the OEM subsystem 260 that are within a master side of the SoC hardware architecture 200. In addition, access control may be performed using an advanced reduced instruction set computing (RISC) architecture machine (ARM) based memory management unit (MMU), or a system MMU (SMMU) from the master side of the SoC hardware architecture 200. Unfortunately, the external debugger 202 may access external subsystem assets (e.g., OEM SS assets 244 and/or SoC SS assets 242) stored elsewhere in SoC hardware architecture 200, such as a double data rate (DDR) memory 240 (e.g., configuration/status registers (CSRs), etc.).

In this configuration, the external debugger 202 accesses external subsystem assets (e.g., OEM SS assets 244 and/or SoC SS assets 242) stored elsewhere in SoC hardware architecture 200 through the second access port 214 of the debug access port 210. This access path continues through a first Clock network-on-chip 230 (e.g., CNoC) and a translation buffer unit 232 (TBU) to a system network-on-chip 234 (SysNoC). The translation buffer unit 232 implements master-side access control to the system network-on-chip 234. In a bypass mode, the translation buffer unit 232 provides the external debugger 202 with debug access to the system network-on-chip 234.

Access to the OEM SS assets 244 and the SoC SS assets 242 stored in the DDR memory 240 through a memory network-on-chip 238 (MemNoC) is protected through an access protection unit 236 (e.g., xPU). According to aspects of the present disclosure, the access protection unit 236 is configured to protect portions of the SoC hardware architecture 200, which may be referred to as access protection (xPU) resource groups. In this example, each DDR region of the DDR memory 240 may be represented as an access protection unit (xPU) resource group of a secure execution environment. The collection of the xPU resource groups defined for the SoC hardware architecture 200 may be referred to as a trustzone(s) of a secure execution environment.

In this configuration, the access protection unit 236 includes hardware configured for slave side access control, such as access to the DDR memory 240 by the external debugger 202. For example, the DDR memory 240 includes DDR regions shown to include the OEM SS assets 244 and the SoC SS assets 242. As a result, each access to an xPU resource group, such as a DDR region of the DDR memory 240, is checked by the access protection unit 236 against, for example, a security attribute carried for the trustzone in the SoC hardware architecture 200. The trustzone may be defined for modem access as well as a secure processing unit (SPU) on a bus (e.g., the system network-on-chip 234). That is, the trustzone is defined by the various xPU resource groups of the SoC hardware architecture 200.

In this configuration of the SoC hardware architecture 200, the access protection unit 236 provides access control from the slave side of the SoC hardware architecture 200. While there is an adequate access control in place for on-chip clients, external access control to prevent access to the OEM SS assets 244 and the SoC SS assets 242 by the external debugger 202 of a third-party OEM or end user is desired. For example, the SoC hardware architecture 200 may implement a 5G algorithm processing subsystem as well as a power management subsystem. Third-party OEM access to these SoC subsystems, as well as certain assets, is strictly prohibited.

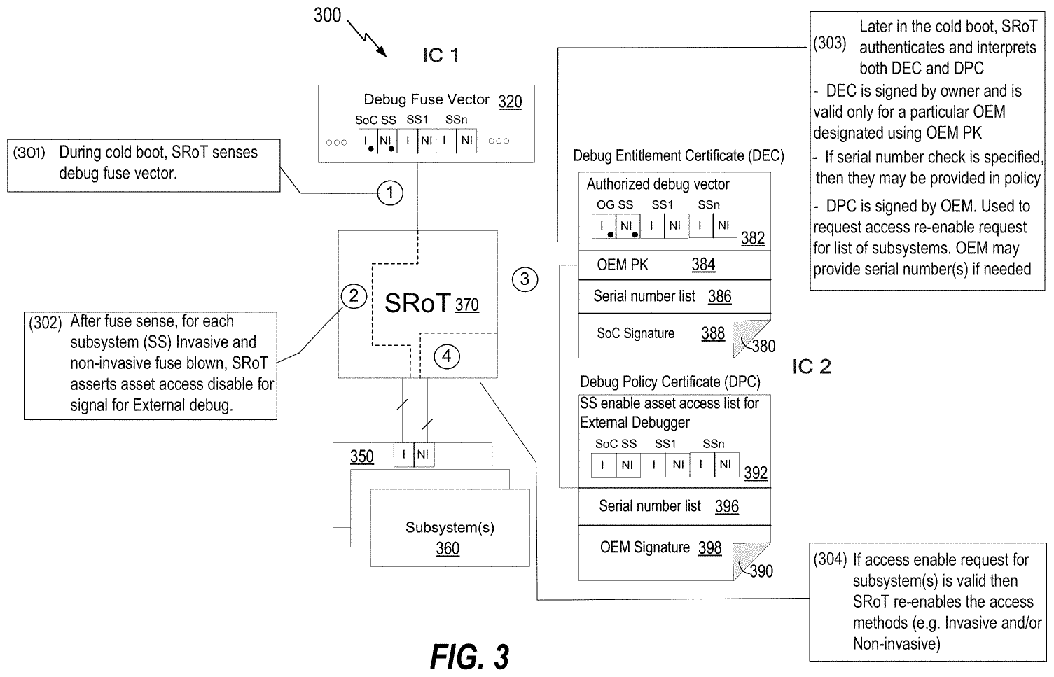

FIG. 3 is a block diagram of a configuration of external debug interface access control for system-on-chip (SoC) hardware architecture subsystem assets, in accordance with aspects of the present disclosure. In one configuration, an SoC hardware architecture 300 includes a debug fuse vector 320, having a set of fuses for each subsystem (SS) of the SoC hardware architecture 300. As described, these subsystems are referred to as “SoC subsystems” or “SoC SS” and other subsystems, such as any other subsystem shared with a third-party, referred to as third-party original equipment manufacturer (OEM) subsystems, “OEM subsystems,” or “OEM SS.”

According to aspects of the present disclosure, the debug fuse vector 320 combines the set of fuses for each subsystem (SS) of the SoC hardware architecture 300 (e.g., from the FROM 220 of FIG. 2). As described, an invasive (I) access flag controls an asset access enable/disable for an invasive method of debugging. In addition, a non-invasive (NI) access flag controls an asset access enable/disable for a non-invasive method of debugging. Invasive (I) access control signals and non-invasive (NI) access control signals are routed to each subsystem of the SoC hardware architecture 300 according to the settings of the debug fuse vector 320. Based on the security permission defined in a security policy (as further described below), the SoC hardware architecture 300 exercises access control and blows fuses of the debug fuse vector 320 for a subset of an SoC subsystem 350 (e.g., SoC SS) and third-party OEM subsystems 360 (e.g., SS1, . . . , SSn).

Thus, when a third-party OEM receives a part including the SoC hardware architecture 300, an external debugger of the third-party has limited access to the subsystem assets (e.g., 350 and/or 360) based on the setting of the debug fuse vector 320. For example, blowing fuses of the debug fuse vector 320 allows for enforcing a most restrictive behavior on the external debugger, should business justification warrant the most limited access. With that as a baseline, a secure root of trust 370 (SRoT) is configured to allow granular subsystem asset access re-enablement for the external debugger of third-party OEMs. Furthermore, the third-party OEMs may use the debug fuse vector 320 to blow fuses associated with the third-party OEM subsystems 360 (e.g., SS1, . . . , SSn) to disable asset access based on their own process specifications.

FIG. 3 shows a configuration of the SoC hardware architecture 300, including the secure root of trust 370 configured according to a security policy to control the assets of the SoC subsystems 350 and the third-party OEM subsystems 360. In this aspect of the present disclosure, the security policy scheme is composed of a debug entitlement certificate 380 (DEC) and a debug policy certificate 390. In this example, the debug entitlement certificate 380 is signed and owned by an owner of the SoC hardware architecture 300 (“SoC owner”). Similarly, the debug policy certificate 390 is signed and owned by a third-party (“third-party OEM”).

In this configuration, the debug entitlement certificate 380 includes an authorized debug vector 382, which is formatted in a manner similar to the debug fuse vector 320. The debug entitlement certificate 380 also includes a public key (PK) of a third-party OEM (e.g., OEM PK 384) that uniquely identifies a given third-party for whom the debug entitlement certificate 380 is valid. Optionally, the debug entitlement certificate 380 includes a list of OEM device serial numbers (e.g., OEM serial number list 386) for which the debug entitlement certificate 380 is valid. The OEM serial number list 386 allows for granular restriction by the security policy. The debug entitlement certificate 380 further includes an SoC signature 388.

In this aspect of the present disclosure, the authorized debug vector 382 dictates a list of subsystems for which asset access is available to a third-party OEM using an external debug interface. This asset access is reflected in hardware through the debug fuse vector 320. That is, the authorized debug vector 382 reflects external debug access permission of each subsystem for the third-party OEM. In other words, the number of subsystems that the SoC owner has blown fuses for in the debug fuse vector 320 should match the number of subsystems in the authorized debug vector 382 for which the third-party OEM does not have external debug access.

In this example, the OEM PK 384 identifies each third-party OEM for whom the debug entitlement certificate 380 is valid. The access capability of each third-party OEM may vary based on the SoC owner's business needs relative to a given third-party OEM. In addition, further restriction of the security policy within the third-party OEM may be employed using serial number validation performed by the secure root of trust 370 according to the serial number list 386. Based on business and/or technical justification, the SoC owner may update the debug entitlement certificate 380 to relax or further restrict subsystem access control, which is a benefit of the security policy based control of the SoC hardware architecture 300.

FIG. 3 also illustrates the debug policy certificate 390, which is used by third-party OEMs to re-enable subsystem asset access for external debug. A third-party OEM uses the debug policy certificate 390 to provide a list of subsystems to enable asset access for external debug. For any subsystems that the SoC owner controls, the access is authorized if and only if conditions in the debug entitlement certificate 380 are met. The combination of the debug fuse vector 320 and the security policy, according to aspects of the present disclosure, solves problems associated with re-enablement of subsystem asset access. In this example, the secure root of trust 370 enforces access control for subsystem assets.

According to aspects of the present disclosure, the secure root of trust 370 provides a secure execution environment for the SoC hardware architecture with a highest level of privilege. The secure root of trust 370 is responsible for subsystem image authentication, attestation, key management, and other like security primitives. For example, at step 301, the secure root of trust 370 senses the debug fuse vector 320 during cold boot (e.g., the first boot after power up of the SoC hardware architecture). With respect to the debug fuse vector 320, at step 302, the secure root of trust 370 routes the invasive (I) and the non-invasive (NI) signals to each subsystem (e.g., 350 and/or 360) at cold boot (after power up), based on debug fuse state reads from the debug fuse vector 320.

The process continues at step 303, in which the secure root of trust 370 authenticates and validates both the debug entitlement certificate 380 and the debug policy certificate 390 later in cold boot. The debug entitlement certificate 380 is signed by the SoC owner (e.g., SoC signature 388) and is valid only for a third-party OEM designated using the OEM public key (e.g., OEM PK 384). The secure root of trust 370 may perform a serial number check based on a serial number list 386 as provided in the debug entitlement certificate 380. The debug policy certificate 390 is signed by the third-party OEM (e.g., OEM signature 398) and may include a serial number list 396.

According to aspects of the present disclosure, the debug policy certificate 390 is used to request an access re-enable request for a list of subsystems in a subsystem asset access enable list 392. The third-party OEM may provide serial number(s) in the serial number list 396, if needed. For example, at step 304, if an access enable request for subsystem(s) in the debug policy certificate 390 is valid, then the secure root of trust 370 re-enables the access methods (e.g., invasive and/or non-invasive). For example, the subsystems (e.g., 350 and/or 360) for which an access enable request is desired are provided in the subsystem asset access enable list 392.

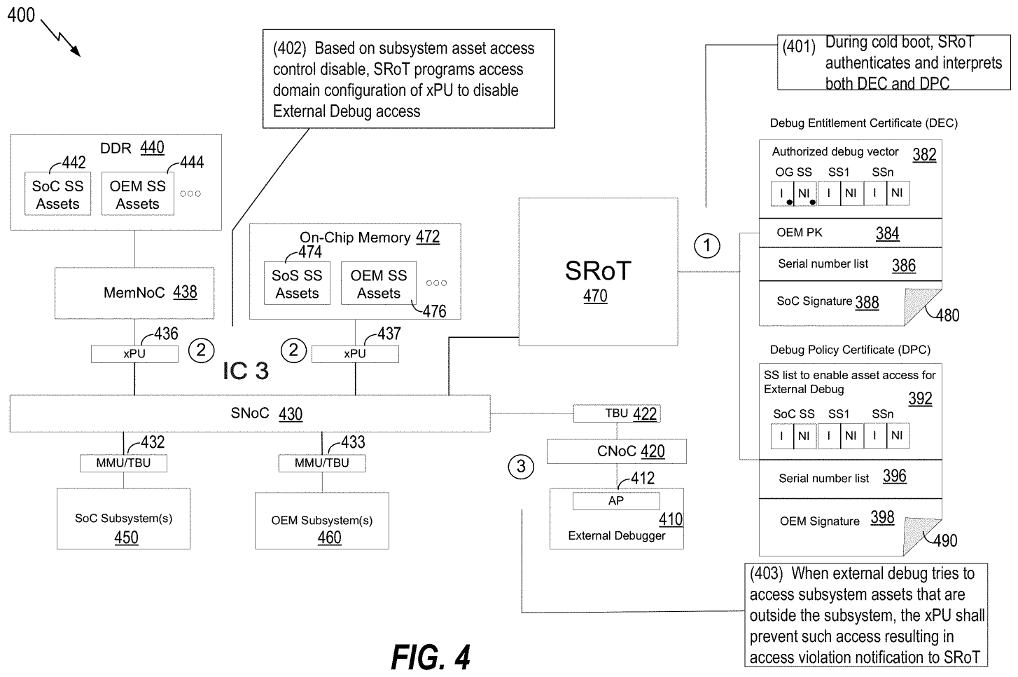

FIG. 4 is a block diagram of a configuration of an SoC hardware architecture 400 to implement subsystem asset external access control, in accordance with aspects of the present disclosure. In this configuration, the SoC hardware architecture 400 includes a secure root of trust 470. The secure root of trust 470 is configured for access separation between various access domains of the SoC hardware architecture 400. For example, the access domains are defined as collections of one or more subsystems, such as SoC subsystem(s) 450 and OEM subsystem(s) 460 within the SoC hardware architecture 400. These access domains refer to subsystems (e.g., 450/460) within the SoC hardware architecture 400 that can own memory-mapped resources, such as system memory or register space.

According to aspects of the present disclosure, the secure root of trust 470 is configured to protect subsystem assets stored inside a subsystem from an external debugger 410. The external debugger 410 attempts to access subsystem assets (e.g., SoC SS assets 442 and/or OEM SS assets 444 and SoC SS assets 474 and/or OEM SS assets 476) stored elsewhere (e.g., in DDR memory 440 or on-chip memory 472) in the SoC hardware architecture 400. In this configuration, the external debugger 410 accesses these subsystem assets through a port 412 (AP) of a debug access port incorporated into the external debugger 410. An access path of the external debugger 410 continues through a first Clock network-on-chip 420 (e.g., CNoC) and a translation buffer unit 422 (TBU) to a system network-on-chip 430 (SNoC). The translation buffer unit 422 provides master-side access control to the system network-on-chip 430. In a bypass mode, the translation buffer unit 422 provides the external debugger 410 with debug access to the system network-on-chip 430.

In this configuration, access control to the SoC subsystem(s) 450 is performed by a first memory management unit/translation buffer unit 432 (MMU/TBU). Similarly, access control to the OEM subsystems 460 is performed by a second MMU/TBU 433 from the master side of the SoC hardware architecture 400. Unfortunately, SoC SS assets 442 and/or OEM SS assets 444 in the DDR memory 440 and the SoC SS assets 474 and/or OEM SS assets 476 stored in the on-chip memory 472 are accessible to the external debugger 410. That is, even if fuses are blown in the debug fuse vector 320 of FIG. 3, the external debugger 410 has access to the assets in the DDR memory 440 through a first access protection unit 436 (e.g., xPU) and a memory network on-chip 438. In addition, the external debugger 410 has access to the assets in the on-chip memory 472 through a second access protection unit 437.

According to aspects of the present disclosure, the secure root of trust 470 may enable/disable access of the external debugger 410 by configuring the first access protection unit 436 and the second access protection unit 437. In this process, at step 401, the secure root of trust 470 authenticates and validates both a debug entitlement certificate 480 and a debug policy certificate 490, which are similar to the debug entitlement certificate 380 and the debug policy certificate 390 of FIG. 3. After validation, at step 402, the secure root of trust 470 interprets both the debug entitlement certificate 480 and the debug policy certificate 490. Based on conditions supplied by the debug entitlement certificate 480, the secure root of trust 470 processes access re-enable requests made via the debug policy certificate 490 by the third-party OEM.

In operation, the external debugger 410 attempts to access assets owned by an access domain. Control over this access domain is also performed at step 402, in which the secure root of trust 470 programs access domain configurations of the first access protection unit 436 and the second access protection unit 437 to enable/disable external debug access based on a subsystem asset access control enable/disable state. For example, the secure root of trust 470 programs slave side accesses to control hardware of the first access protection unit 436 and the second access protection unit 437 to achieve these specifications.

In this aspect of the present disclosure, the first access protection unit 436 and the second access protection unit 437 are modified to enable software based access domain control of the SoC hardware architecture 400 for external debug. That is, if a subsystem asset access is disabled in the debug entitlement certificate 480 and the debug policy certificate 490, then the secure root of trust 470 programs the first access protection unit 436 and/or the second access protection unit 437 to prevent external debug access. Conversely, if a subsystem asset access is enabled in the debug entitlement certificate 480 and the debug policy certificate 490, the secure root of trust 470 programs the first access protection unit 436 and/or the second access protection unit 437 to enable external debug access. As a result, the external debugger 410 is provided with access to any assets of an access domain (AD) to which a given subsystem belongs.

At step 403, when the external debugger 410 attempts access to external subsystem assets that are outside the internal subsystems of the SoC hardware architecture 400, this access attempt is denied. For example, the first access protection unit 436 and/or the second access protection unit 437 are programmed to prevent such access, resulting in an access violation notification to the secure root of trust 470. The secure root of trust 470 protects an access domain architecture of the SoC hardware architecture 400 by programming the first access protection unit 436 and/or the second access protection unit 437. The conjunction of the security policy and slave side access control provided by the secure root of trust 470 solves the external access control problem associated with the external debugger 410.

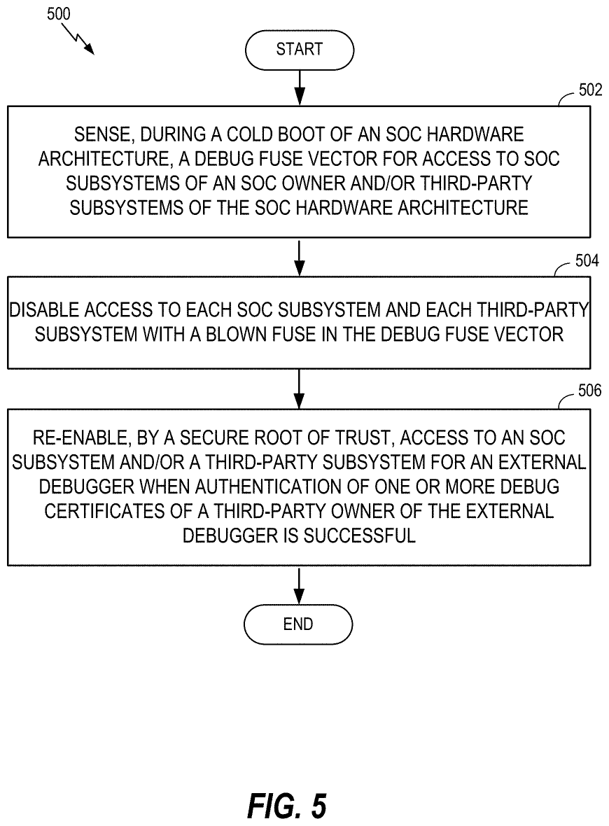

FIG. 5 is a flow diagram illustrating a method for external access control to protect system-on-chip (SoC) subsystems and stored subsystem assets, according to aspects of the present disclosure. A method 500 begins at block 502, in which a debug fuse vector is sensed, during a cold boot of an SoC hardware architecture, for access to SoC subsystems of an SoC owner and/or third-party subsystems of the SoC hardware architecture. For example, as illustrated in FIG. 3, the secure root of trust 370 senses the debug fuse vector 320 during cold boot, which refers to a first boot up after power up of the SoC hardware architecture 300.

Referring again to FIG. 5, at block 504, access is disabled to each SoC subsystem and each third-party subsystem with a blown fuse in the debug fuse vector. For example, as shown in FIG. 3, based on the debug fuse vector 320, the secure root of trust 370 routes the invasive (I) and the non-invasive (NI) access control signals to each subsystem. For example, the access control signals are routed to the SoC subsystems 350 and the third-party OEM subsystems 360 at cold boot (after power up), based on debug fuse state reads from the debug fuse vector 320.

At block 506, a secure root of trust re-enables access to an SoC subsystem and/or a third-party subsystem for an external debugger when authentication of one or more debug certificates of a third-party owner of the external debugger is successful. For example, in FIG. 3, if an access enable request for subsystem(s) in the debug policy certificate 390 is valid, then the secure root of trust 370 re-enables the access methods (e.g., invasive and/or non-invasive). For example, the subsystems (e.g., the SoC subsystems 350 and/or the third-party OEM subsystems 360) for which an access enable request is desired are provided in the subsystem asset access enable list 392.

The method 500 may further include disabling access of the external debugger 410 to the on-chip subsystem assets when a subsystem asset access control disable state is detected, for example, as shown in FIG. 4. The method 500 may further include issuing a first challenge to the external debugger 410 based on an SoC owner signed version of the debug entitlement certificate 380. In addition, the method 500 may also include issuing a second challenge to the external debugger 410 when the first challenge is authenticated. The second challenge is based on a third-party owner signed version of the debug policy certificate 390 (e.g., signed and owned by a third-party “third-party OEM”). This additional process includes granting the third-party owner access, via the external debugger 410, to SoC subsystem assets.

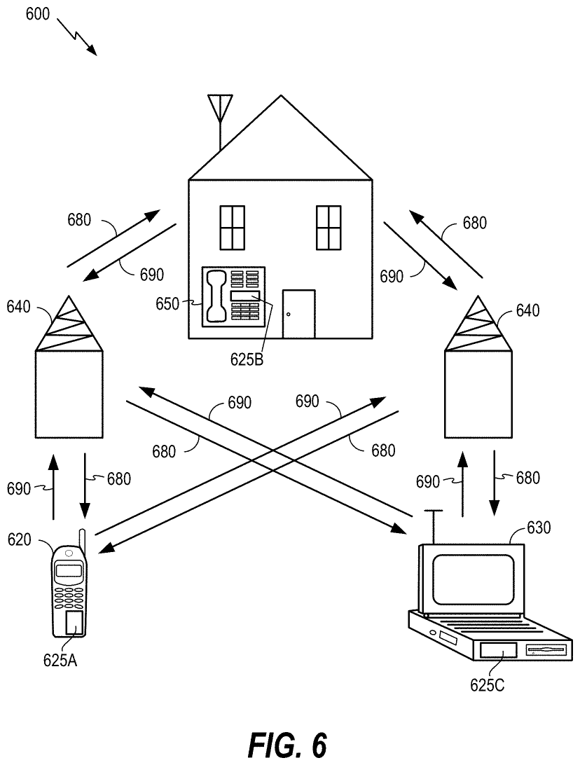

FIG. 6 is a block diagram showing an exemplary wireless communications system 600 in which a configuration of the disclosure may be advantageously employed. For purposes of illustration, FIG. 6 shows three remote units 620, 630, and 650, and two base stations 640. It will be recognized that wireless communications systems may have many more remote units and base stations. Remote units 620, 630, and 650 include integrated circuit (IC) devices 625A, 625B, and 625C, which include the disclosed security policy mechanism. It will be recognized that any device containing an IC may also include the disclosed security policy mechanism, including the base stations, switching devices, and network equipment. FIG. 6 shows forward link signals 680 from the base stations 640 to the remote units 620, 630, and 650, and reverse link signals 690 from the remote units 620, 630, and 650 to base stations 640.

In FIG. 6, a remote unit 620 is shown as a mobile telephone, a remote unit 630 is shown as a portable computer, and a remote unit 650 is shown as a fixed location remote unit in a wireless local loop system. For example, the remote units may be a mobile phone, a hand-held personal communications systems (PCS) unit, a portable data unit such as a personal data assistant, a GPS enabled device, a navigation device, a set top box, a music player, a video player, an entertainment unit, a fixed location data unit such as meter reading equipment, or any other device that stores or retrieves data or computer instructions, or any combination thereof. For example, a remote unit including the low power memory sub-system may be integrated within a vehicle control system, a server computing system, or other like system specifying critical data integrity. Although FIG. 6 illustrates IC devices 625A, 625B, and 625C, which include the disclosed security policy mechanism, the disclosure is not limited to these exemplary illustrated units. Aspects of the present disclosure may be suitably employed in any device, which includes the security policy mechanism.

For a firmware and/or software implementation, the methodologies may be implemented with modules (e.g., procedures, functions, and so on) that perform the described functions. Any machine-readable medium tangibly embodying instructions may be used in implementing the methodologies described. For example, software codes may be stored in a memory and executed by a processor unit. Memory may be implemented within the processor unit or external to the processor unit. As used the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or code on a non-transitory computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include RAM, ROM, EEPROM, CD-ROM or other optical disk storage, magnetic disk storage or other magnetic storage devices, or other medium that can be used to store desired program code in the form of instructions or data structures and that can be accessed by a computer. Disk and disc, as used, include compact disc (CD), laser disc, optical disc, digital versatile disc (DVD) and Blu-ray® disc, where disks usually reproduce data magnetically, while discs reproduce data optically with lasers. Combinations of the above should also be included within the scope of computer-readable media.

In addition to storage on computer-readable medium, instructions and/or data may be provided as signals on transmission media included in a communications apparatus. For example, a communications apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions, and alterations can be made without departing from the technology of the disclosure as defined by the appended claims. For example, relational terms, such as “above” and “below” are used with respect to a substrate or electronic device. Of course, if the substrate or electronic device is inverted, above becomes below, and vice versa. Additionally, if oriented sideways, above and below may refer to sides of a substrate or electronic device. Moreover, the scope of the present application is not intended to be limited to the particular configurations of the process, machine, manufacture, composition of matter, means, methods, and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding configurations described may be utilized according to the present disclosure. Accordingly, the appended claims are intended to include within their scope such processes, machines, manufacture, compositions of matter, means, methods, or steps.

Those of skill would further appreciate that the various illustrative logical blocks, modules, circuits, and algorithm steps described in connection with the disclosure may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure may be implemented or performed with a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The steps of a method or algorithm described in connection with the disclosure may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b, and c. All structural and functional equivalents to the elements of the various aspects described throughout this disclosure that are known or later come to be known to those of ordinary skill in the art are expressly incorporated by reference and are intended to be encompassed by the claims. Moreover, nothing disclosed is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “a step for.”

What is claimed is:

1. A method for external access control to protect system-on-chip (SoC) subsystems and stored subsystem assets, the method comprising:
sensing, during a cold boot of an SoC hardware system, a debug fuse vector for access to SoC subsystems of an SoC owner and/or third-party subsystems of an SoC hardware architecture;
disabling access to each SoC subsystem with a blown fuse in the debug fuse vector; and
re-enabling, by a secure root of trust, access to an SoC subsystem and/or a third-party subsystem for an external debugger when authentication of one or more debug certificates of a third-party owner of the external debugger is successful.

2. The method of claim 1, further comprising programming an access protection unit according to the debug fuse vector to prevent access to each SoC subsystem with the blown fuse in the debug fuse vector.

3. The method of claim 1, further comprising programming an access protection unit according to the debug fuse vector to prevent access to each third-party subsystem of the SoC hardware architecture with the blown fuse in the debug fuse vector.

4. The method of claim 1, in which re-enabling comprises:
issuing a first challenge to the external debugger based on an SoC owner signed debug entitlement certificate;
issuing a second challenge to the external debugger based on a third-party owner signed debug policy certificate when the first challenge is authenticated; and
granting the third-party owner access, via the external debugger, to SoC subsystem assets.

5. The method of claim 1, further comprising:
determining a subsystem asset access control enable/disable state from the debug fuse vector; and
programming, by a secure root of trust, an access domain configuration of a first access protection unit to enable/disable external debug access to on-chip subsystem assets based on the subsystem asset access control enable/disable state.

6. The method of claim 5, in which programing comprises disabling access of the external debugger to the on-chip subsystem assets when a subsystem asset access control disable state is detected.

7. The method of claim 1, further comprising:
detecting an access attempt by the external debugger to access subsystem assets outside the SoC hardware architecture;
preventing, by an access protection unit, the access attempt by the external debugger; and
issuing, by the access protection unit, an access violation notification to a secure root of trust.

8. A non-transitory computer-readable medium having program code recorded thereon for external access control to protect system-on-chip (SoC) subsystems and stored subsystem assets, the program code executed by a processor and comprising:
program code to sense, during a cold boot of an SoC hardware system, a debug fuse vector for access to SoC subsystems of an SoC owner and/or third-party subsystems of an SoC hardware architecture;
program code to disable access to each SoC subsystem with a blown fuse in the debug fuse vector; and
program code to re-enable, by a secure root of trust, access to an SoC subsystem and/or a third-party subsystem for an external debugger when authentication of one or more debug certificates of a third-party owner of the external debugger is successful.

9. The non-transitory computer-readable medium of claim 8, further comprising program code to program an access protection unit according to the debug fuse vector to prevent access to each SoC subsystem with the blown fuse in the debug fuse vector.

10. The non-transitory computer-readable medium of claim 8, further comprising program code to program an access protection unit according to the debug fuse vector to prevent access to each third-party subsystem of the SoC hardware architecture with the blown fuse in the debug fuse vector.

11. The non-transitory computer-readable medium of claim 8, in which the program code to re-enable comprises:
program code to issue a first challenge to the external debugger based on an SoC owner signed debug entitlement certificate;
program code to issue a second challenge to the external debugger based on a third-party owner signed version of a debug policy certificate when the first challenge is authenticated; and
program code to grant the third-party owner access, via the external debugger, to SoC subsystem assets.

12. The non-transitory computer-readable medium of claim 8, further comprising:
program code to determine a subsystem asset access control enable/disable state from the debug fuse vector; and
program code to program, by a secure root of trust, an access domain configuration of a first access protection unit to enable/disable external debug access to on-chip subsystem assets based on the subsystem asset access control enable/disable state.

13. The non-transitory computer-readable medium of claim 12, in which the program code to program comprises program code to disable access of the external debugger to the on-chip subsystem assets when a subsystem asset access control disable state is detected.

14. The non-transitory computer-readable medium of claim 8, further comprising:
program code to detect an access attempt by the external debugger to access subsystem assets outside the SoC hardware architecture;
program code to prevent, by an access protection unit, the access attempt by the external debugger; and
program code to issue, by the access protection unit, an access violation notification to a secure root of trust.

15. A system for external access control to protect system-on-chip (SoC) subsystems and stored subsystem assets, the system comprising:
a debug fuse vector to define access to SoC subsystems of an SoC owner and/or third-party subsystems of an SoC hardware architecture;
an access protection unit configured to prevent access to each SoC subsystem with a blown fuse in the debug fuse vector; and
a secure root of trust configured to re-enable, by, access to an SoC subsystem and/or a third-party subsystem for an external debugger when authentication of one or more debug certificates of a third-party owner of the external debugger is successful.

16. The system of claim 15, in which the secure root of trust is configured to sense, during a cold boot of an SoC hardware system, the debug fuse vector, and configured to program the access protection unit according to the debug fuse vector to prevent access to each SoC subsystem with the blown fuse in the debug fuse vector.

17. The system of claim 15, in which the secure root of trust is configured to sense, during a cold boot of an SoC hardware system, the debug fuse vector, and configured to program the access protection unit according to the debug fuse vector to prevent access to each third-party subsystem of the SoC hardware architecture with the blown fuse in the debug fuse vector.

18. The system of claim 15, in which the secure root of trust is configured to issue a first challenge to the external debugger based on an SoC owner signed debug entitlement certificate, configured to issue a second challenge to the external debugger based on a third-party owner signed debug policy certificate when the first challenge is authenticated, and configured to grant the third-party owner access, via the external debugger, to SoC subsystem assets.

19. The system of claim 15, the secure root of trust is configured to determine a subsystem asset access control enable/disable state from the debug fuse vector, configured to program an access domain configuration of the access protection unit to enable/disable external debug access to on-chip subsystem assets based on the subsystem asset access control enable/disable state, and configured to disable access of the external debugger to the on-chip subsystem assets when a subsystem asset access control disable state is detected.

20. The system of claim 15, in which the access protection unit is configured to detect an access attempt by the external debugger to access subsystem assets outside the SoC hardware architecture, configured to prevent the access attempt by the external debugger; and configured to issue an access violation notification to the secure root of trust.
